(19) United States
(12) Patent Application Publication
(10) Pub. No.: US 2018/0062494 A1
(43) Pub. Date: Mar. 1, 2018

(54) ELECTRIC GENERATOR, A WIRE TRAY MODULE, AND A MAGNETIC PLATE MODULE

(71) Applicant: Chiung-Hao CHEN, Tainan City (TW)

(72) Inventors: Chiung-Hao CHEN, Tainan City (TW); Hsin-Hung LIU, Tainan City (TW)

(21) Appl. No.: 15/689,511

(22) Filed: Aug. 29, 2017

(30) Foreign Application Priority Data
Aug. 30, 2016 (TW) 105213251

(51) Int. Cl. H02K 47/00; H02K 7/116; H02K 7/10

(52) U.S. Cl. CPC H02K 47/00; H02K 53/00; H02K 7/1004; H02K 7/116

(57) ABSTRACT

An electric generator includes an electric generating device and a driving device. The electric generating device includes a supporting frame, and an electric generating mechanism including a transmission shaft rotatably mounted to the supporting frame, a wire tray unit disposed around the transmission shaft, and a magnetic plate unit including a magnetic plate body co-rotatably sleeved on the transmission shaft and multiple magnets mounted to the magnetic plate body. The wire tray unit generates an electric power induced by relative rotation of the wire tray unit and the magnets. The driving device is connected to the transmission shaft, and is driven by a part of the electric power to drive rotation of the transmission shaft.

### CROSS-REFERENCE TO RELATED APPLICATION

This application claims priority of Taiwanese Utility Model Patent Application No. 105213251, filed on Aug. 30, 2016.

### FIELD

The disclosure relates to an electric generator, a wire tray module used by the electric generator, and a magnetic plate module used by the electric generator.

### BACKGROUND

The increase of worldwide population and growing industries lead to energy shortage and exacerbating greenhouse effect. Therefore, the development of green energy, such as solar energy, wind power generation, hydraulic power generation, etc. has become an important topic in modern society.

A conventional way of power generation utilizes natural power, such as hydraulic power, wind power, etc. to drive rotation of a wire tray adjacent to a magnetic plate such that wire tray generates an electric power induced by the relative rotation of the wire tray and the magnetic plate, thereby transferring the natural power to electric power.

It is desirable to increase the efficiency of the conventional power generation method.

### SUMMARY

Therefore, a first aspect of the present disclosure is to provide an electric generator.

The electric generator includes at least one electric generating device and a driving device.

The at least one electric generating device includes a supporting frame and at least one electric generating mechanism. The at least one electric generating mechanism is mounted to the supporting frame, and includes a transmission shaft rotatably mounted to the supporting frame, a wire tray unit disposed around the transmission shaft and fixedly mounted to the supporting frame, and a magnetic plate unit sleeved on the transmission shaft and including at least one magnetic plate module that includes a magnetic plate body co-rotatably sleeved on the transmission shaft and a plurality of angularly spaced-apart magnets mounted to the magnetic plate body. The wire tray unit generates an electric power induced by relative rotation of the wire tray unit and the magnets of the magnetic plate unit.

The driving device is connected to the transmission shaft and is driven by a part of the electric power to drive rotation of the transmission shaft.

A second aspect of the present disclosure is to provide a wire tray module adapted to be mounted to two supporting rods of a supporting frame of an electric generator.

The wire tray module includes at least one coil member and a covering member.

The covering member has an annular cover body that encloses the at least one coil member, and two protrusions that extend from the cover body and away from each other and that are adapted to be respectively supported on the supporting rods.

A third aspect of the present disclosure is to provide a magnetic plate module that is adapted to be used by an electric generator.

The magnetic plate module includes a magnetic plate body and a plurality of magnets. The magnetic plate body has a plurality of first through holes spaced apart from each other and arranged around a center axis of the magnetic plate body. The magnets respectively extend through the first mounting holes and are exposed from opposite sides of the magnetic plate body.

### BRIEF DESCRIPTION OF THE DRAWINGS

Other features and advantages of the present disclosure will become apparent in the following detailed description of the embodiments and variation with reference to the accompanying drawings, of which:

FIG. 1 is a perspective view of a first embodiment of an electric generator according to the present disclosure;

FIG. 2 is a top view of the first embodiment;

FIG. 3 is a partially exploded perspective view of the first embodiment, with a case of an electric generating device of the first embodiment removed;

FIG. 4 is a schematic side view of a wire tray unit of the first embodiment;

FIG. 5 is a partially exploded perspective view of a magnetic plate unit of the first embodiment;

FIG. 6 is a schematic block diagram of the first embodiment;

FIG. 7 is perspective view of a second embodiment of the electric generator according to the present disclosure;

FIG. 8 is perspective view of a third embodiment of the electric generator according to the present disclosure;

FIG. 9 is a side view of the third embodiment, with cases of electric generating devices of the third embodiment removed;

FIG. 10 is a perspective view of a fourth embodiment of the electric generator according to the present disclosure, with cases of electric generating devices of the fourth embodiment removed;

FIG. 11 is a side view of the fourth embodiment, with the cases of the electric generating devices of the fourth embodiment removed;

FIG. 12 is a perspective view of a variation of the fourth embodiment, with the cases of the electric generating devices of the fourth embodiment removed; and

FIG. 13 is a side view of a fifth embodiment of the electric generator according to the present disclosure, with cases of electric generating devices of the fifth embodiment removed.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

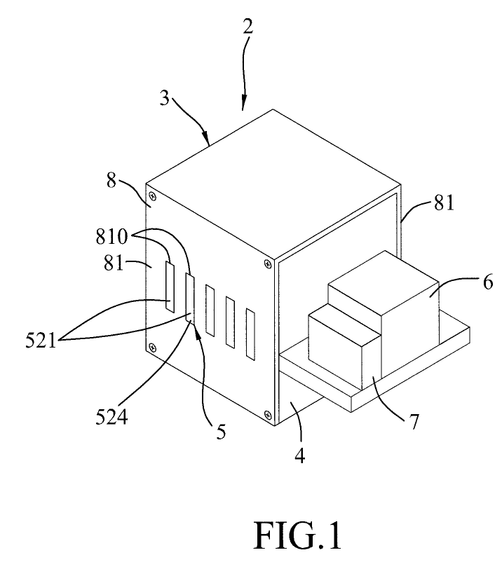

Referring to FIGS. 1 to 3, a first embodiment of an electric generator 2 according to the present disclosure includes an electric generating device 3, a driving device 6 and a power controller 7.

The electric generating device 3 includes a supporting frame 4, an electric generating mechanism 5 and a case 8.

The supporting frame 4 includes two spaced-apart installation walls 41, and two parallel and spaced-apart supporting rods 42 interconnecting the installation walls 41.

The electric generating mechanism 5 is mounted to the supporting frame 4, and includes a transmission shaft 51 rotatably mounted to the installation walls 41 of the supporting frame 4, a wire tray unit 52 disposed around the transmission shaft 51 and fixedly mounted to the supporting rods 42 of the supporting frame 4, and a magnetic plate unit 53 sleeved on the transmission shaft 51.

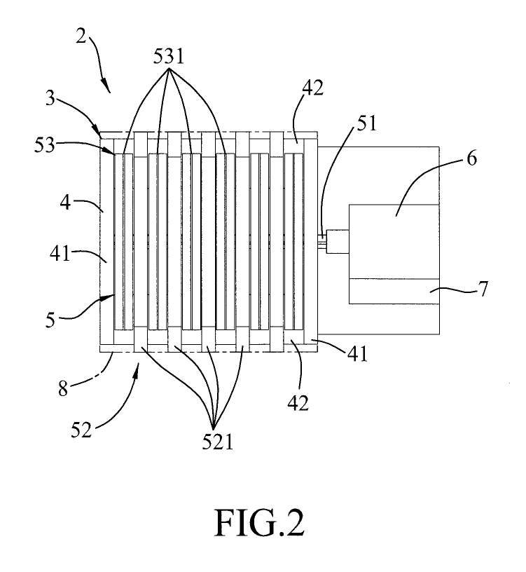

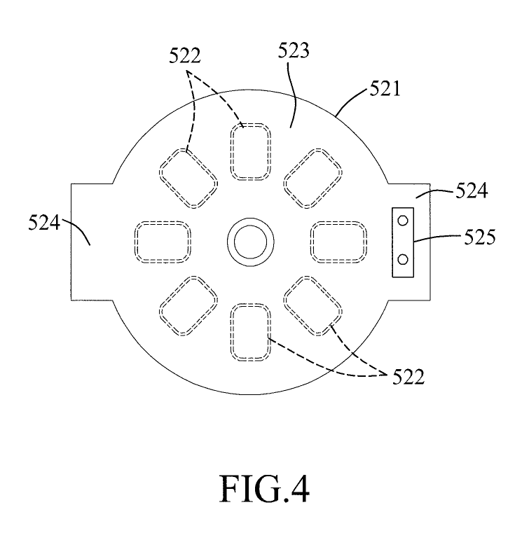

Referring to FIGS. 2 to 4, the wire tray unit 52 includes a plurality of wire tray modules 521 that are disposed around the transmission shaft 51, and that are fixedly mounted to the supporting rods 42. Each of the wire tray modules 521 includes a plurality of angularly equidistant coil members 522, and a covering member having an annular cover body 523 enclosing the coil members 522 and being disposed around the transmission shaft 51, two protrusions 524 that extend from the cover body 523 and away from each other and that are respectively supported on the supporting rods 42, and an output end piece 525 that is disposed on one of the protrusions 524 and that is electrically connected to the coil members 522. The cover body 523 of each of the wire tray modules 521 completely covers the coil members 522 of a corresponding one of the wire tray modules 521 to separate the coil members 522 from the environment. In this embodiment, the cover body 523 and the protrusions 524 of each of the wire tray modules 521 is made of a water-proof material, such as epoxy, etc., and may be changed according to practical requirements.

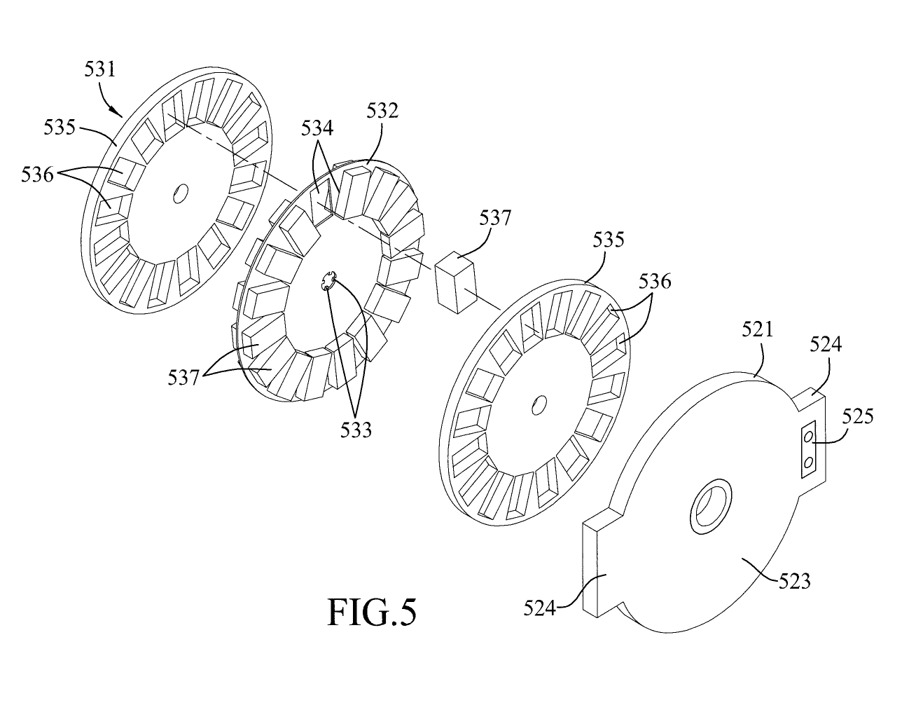

Referring to FIGS. 2, 3 and 5, the magnetic plate unit 53 includes a plurality of magnetic plate modules 531 that are co-rotatably sleeved on the transmission shaft 51. The wire tray modules 521 and the magnetic plate modules 531 are alternatively arranged along the transmission shaft 51. Each of the magnetic plate modules 531 includes a magnetic plate body 532 that is co-rotatably sleeved on the transmission shaft 51, two side plates 535 that are respectively connected to opposite sides of the magnetic plate body 532, and a plurality of angularly equidistant magnets 537 mounted to the magnetic plate body 532.

In this embodiment, the transmission shaft 51 has a plurality of transmission grooves 510 that extend along a longitudinal direction of the transmission shaft 51. The magnetic plate body 532 of each of the magnetic plate modules 531 includes a plurality of protrusions 533 that respectively engage the transmission grooves 510 of the transmission shaft 51, such that the magnetic plate modules 531 are co-rotatable with the transmission shaft 51. The magnetic plate body 532 of each of the magnetic plate modules 531 has a plurality of first mounting holes 534 that are arranged around the transmission shaft 51 and spaced apart from each other. Each of the side plates 535 of each of the magnetic plate modules 531 has a plurality of second mounting holes 536 that are respectively registered with the first mounting holes 534 of the magnetic plate body 532 of the magnetic plate module 531. Each of the magnets 537 of each of the magnetic plate modules 531 extends through corresponding registered ones of the first and second mounting holes 534, 536, exposed from the side plates 535 of the magnetic plate module 531, and immediately adjacent to two corresponding ones of the wire tray modules 521. In this embodiment, two sides of each of the magnets 537 of each of the magnetic plate modules 531 respectively flush with the side plates 535 of the magnetic plate module 531. In this embodiment, each of the side plates 535 of each of the magnetic plate modules 531 is made of a nonmagnetic material, such as plastic, phenol formaldehyde resin, etc., and may be changed according to practical requirements.

When the electric generator 2 is in operation, each of the wire tray modules 521 of the wire tray unit 52 generates an electric power induced by relative rotation of the corresponding wire tray module 521 and the magnets 537 of two adjacent ones of the magnetic plate modules 531 of the magnetic plate unit 53.

The driving device 6 is connected to the transmission shaft 51 and is driven by a part of the electric power to drive rotation of the transmission shaft 51. In this embodiment, the driving device 6 is composed of a motor (not shown) and a transmission mechanism (not shown), and is operable by the power controller 7 to drive rotation of the transmission shaft 51, such that the magnetic plate modules 531 are driven by the transmission shaft 51 to rotate relative to the wire tray modules 521. The structure of the driving device 6 is not limited to a combination of the motor and the transmission mechanism, and may be changed according to practical requirements.

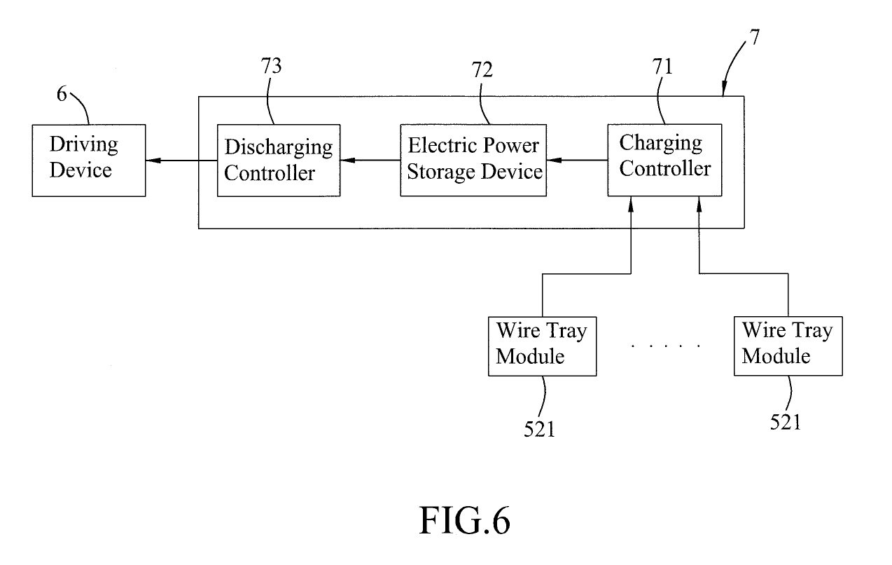

Referring to FIGS. 1 to 3 and 6, the power controller 7 electrically interconnects the wire tray unit 52 of the electric generating mechanism 5 of the electric generating device 3 and the driving device 6. The power controller 7 includes a charging controller 71 that is electrically connected to the wire tray modules 521 of the wire tray unit 52 and that receives the electric power generated by the wire tray unit 52, an electric power storage device 72 that is electrically connected to the charging controller 71 and that stores the electric power delivered from the charging controller 71, and a discharging controller 73 that is electrically connected to the electric power storage device 72 and that receives the electric power delivered from the electric power storage device 72 and that delivers the part of the electric power to the driving device 6 to drive operation of the driving device 6. In this embodiment, the charging controller 71 is capable of stabilizing and rectifying the electric power generated by the wire tray unit 52. The discharging controller 73 is capable of processing the part of the electric power before being delivered to the driving device 6, such as transforming DC current into AC current.

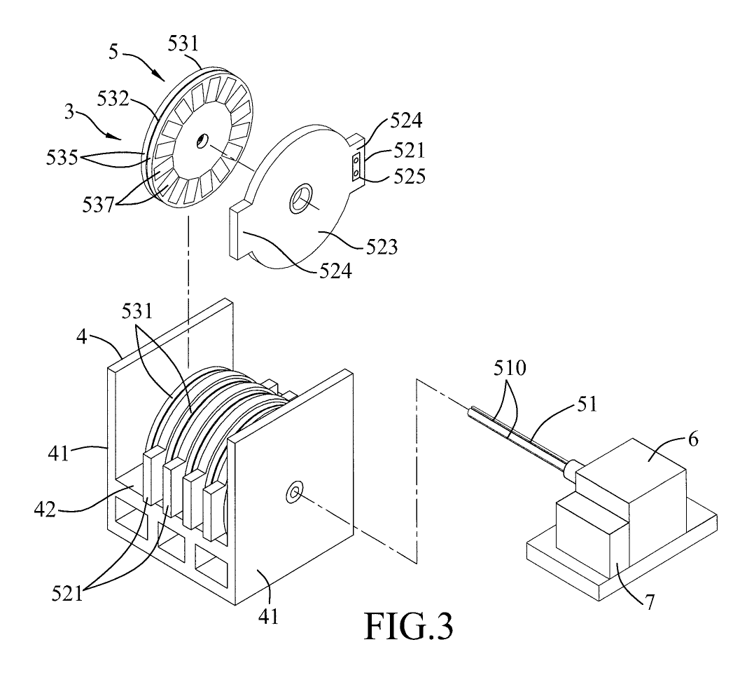

Referring to FIGS. 1 and 3, the case 8 may be made of a magnetic resistant material, is mounted to the supporting frame 4, and covers the electric generating mechanism 5. The case 8 includes two case walls 81 that are formed with a plurality of positioning holes 810, each of which is for engagement of a respective one of the protrusions 524 of the cover bodies 523 of the wire tray modules 521.

Referring to FIGS. 2, 3 and 6, when the electric generator 2 is in operation, the electric power storage device 72 provides a part of the electric power stored therein to drive rotation of the transmission shaft 51, such that the wire tray modules 521 of the wire tray unit 52 generate electric power induced by relative rotation of the wire tray modules 521 and the magnetic plate modules 531. The electric power generated by the wire tray modules 521 is then transferred to the charging controller 71 to be stored in the electric power storage device 72. By changing the numbers of the wire tray modules 521, the magnetic plate modules 531, the coil members 522 of each of the wire tray modules 521 and the magnets 537 of each of the magnetic plate modules 531, the electric power capacity can be adjusted.

In certain embodiments, the wire tray unit 52 may include only two wire tray modules 521, and the magnetic plate unit 53 may include only one magnetic plate module 531. The wire tray modules 521 are disposed around the transmission shaft 51 and are respectively located at opposite sides of the magnetic plate module 531. Each of the wire tray modules 521 generates an electric power induced by relative rotation of the wire tray module 521 of a corresponding one of the wire tray modules 521 and the magnets 537 of the magnetic plate module 531 of the magnetic plate unit 53.

In certain embodiments, each of the magnetic plate modules 531 may include only one side plate 535. The side plates 535 of each of the magnetic plate modules 531 may even be omitted based on actual requirements.

In certain embodiments, the positioning holes 810 of the case walls 81 of the case 8 may be omitted. The supporting rods 42 may be formed with a plurality of indentations (not shown) for respectively receiving the protrusions 524 of the wire tray modules 521.

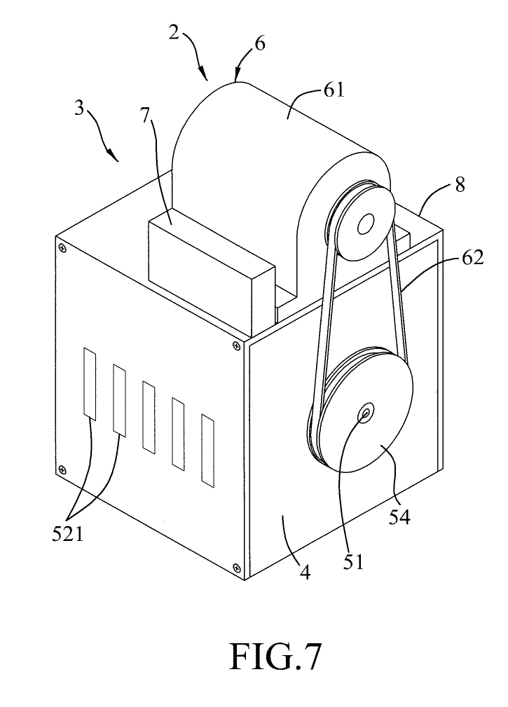

Referring to FIG. 7, a second embodiment of the electric generator 2 according to the present disclosure has a structure modified from that of the first embodiment.

In the second embodiment, the electric generating mechanism 5 further includes a connecting member 54 that is co-rotatably connected to the transmission shaft 51 and that is exposed from the supporting frame 4. The driving device 6 includes a driving unit 61 that is mounted to a top side of the supporting frame 4, and a driving member 62 that is connected between the driving unit 61 and the connecting member 54, such that the driving unit 61 can drive rotation of the connecting member 54 through the driving member 62. In other words, in this embodiment, the driving unit 61 and the transmission shaft 51 are not co-axially arranged, and are co-rotatably driven by the driving member 62.

In this embodiment, the driving unit 61 is composed of a motor (not shown) and a transmission mechanism (not shown). It should be noted that the structure of the driving unit 61 is not limited to a combination of the motor and the transmission mechanism, and may be changed according to practical requirements. The connecting member 54 may be a belt pulley, and the driving member 62 may be a transmission belt. Alternatively, the connecting member 54 may be a gear, and the driving member 62 may be a chain. It should be noted that the structure of the connecting member 54 and the driving member 62 may be changed according to practical requirements, as long as the driving unit 61 and the transmission shaft 51 can be co-rotatably driven.

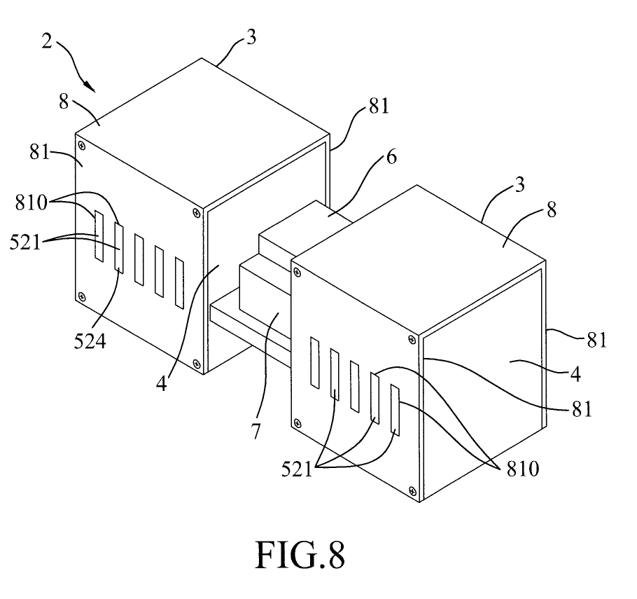

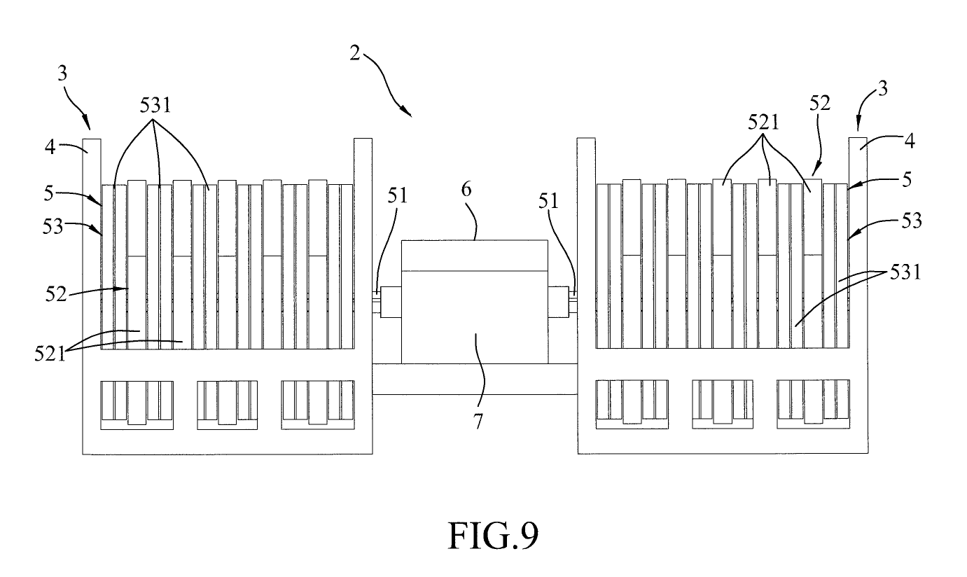

Referring to FIGS. 8 and 9, a third embodiment of the electric generator 2 according to the present disclosure has a structure modified from that of the first embodiment.

In the third embodiment, the electric generator 2 includes two electric generating devices 3 that are respectively disposed adjacent to opposite sides of the driving device 6, and each includes the transmission shaft 51 connected to the driving device 6, which is operable to drive rotation of the transmission shafts 51 of the electric generating mechanisms 5 of the electric generating devices 3.

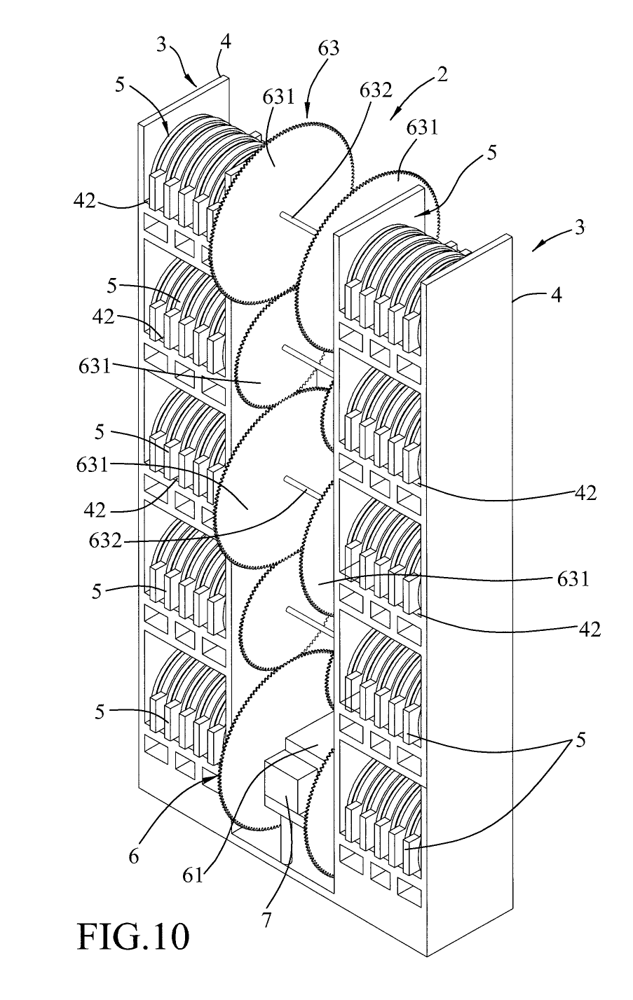

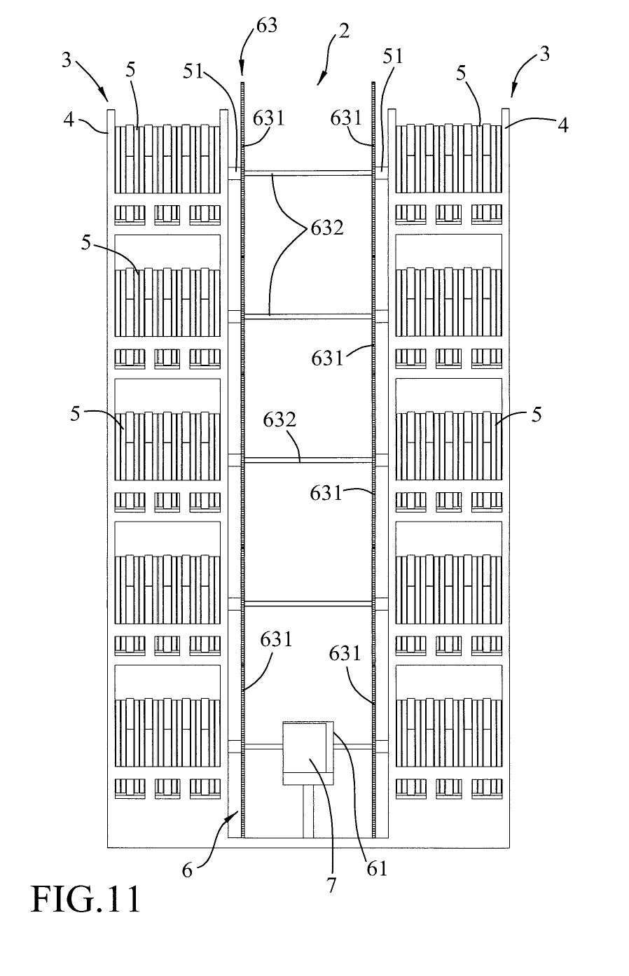

Referring to FIGS. 10 and 11, a fourth embodiment of the electric generator 2 according to the present disclosure has a structure modified from that of the third embodiment.

In the fourth embodiment, the supporting frame 4 of each of the electric generating devices 3 includes a plurality of the supporting rods 42 that are horizontally spaced apart from each other and are vertically disposed. Each of the electric generating devices 3 includes a plurality of electric generating mechanisms 5 that are mounted to the supporting frame 4 of the electric generating device 3 and that are vertically spaced apart from each other.

The driving device 6 includes the driving unit 61 that is connected to one of the transmission shafts 51 of the electric generating mechanisms 5 of each of the electric generating devices 3, and a synchronizing mechanism 63 that is connected to the transmission shafts 51 of the electric generating mechanisms 5 of the electric generating devices 3. The driving unit 61 is operable to drive rotation of the one of the transmission shafts 51 of the electric generating mechanisms 5 of each of the electric generating devices 3 and to drive operation of the synchronizing mechanism 63 such that the synchronizing mechanism 63 drives synchronous rotation of the transmission shafts 51 of the electric generating mechanisms 5 of the electric generating devices 3.

In this embodiment, the synchronizing mechanism 63 includes a plurality of transmission gears 631 and a plurality of synchronizing shafts 632. The transmission gears 631 are co-rotatably and respectively sleeved on the transmission shafts 51 of the electric generating mechanisms 5 of the electric generating devices 3. Ones of the transmission gears 631 connected to the transmission shafts 51 of the electric generating mechanisms 5 of each of the electric generating devices 3 co-rotatably mesh with each other. Each of the synchronizing shafts 632 co-rotatably interconnects one of the transmission gears 631 connected to one of the transmission shafts 51 of the electric generating mechanisms 5 of one of the electric generating devices 3 and a corresponding one of the transmission gears 631 connected to one of the transmission shafts 51 of the electric generating mechanisms 5 of the other one of the electric generating devices 3.

It should be noted that the synchronizing shafts 632 may be omitted according to practical requirements, as long as the transmission gears 631 are co-rotatably mesh with each other.

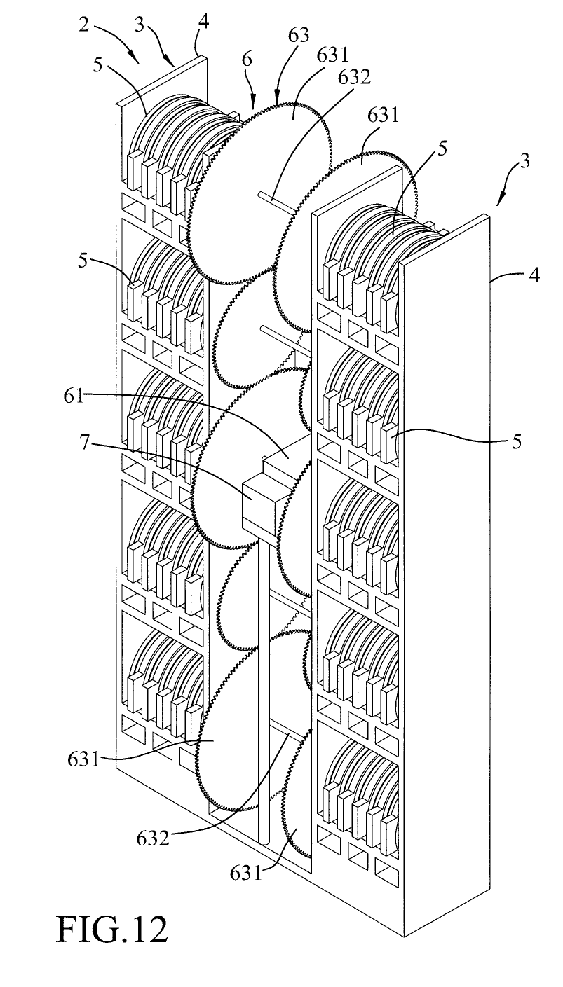

Referring to FIG. 12, in a variation of the fourth embodiment, the driving device 6 can be elevated by a support frame, and connected to the electric generating mechanisms 5 of corresponding two of the electric generating devices 3.

It should be noted that the electric generator 2 may include only one electric generating device 3 that includes a plurality of the electric generating mechanisms 5, which may be horizontally arranged instead of being vertically arranged.

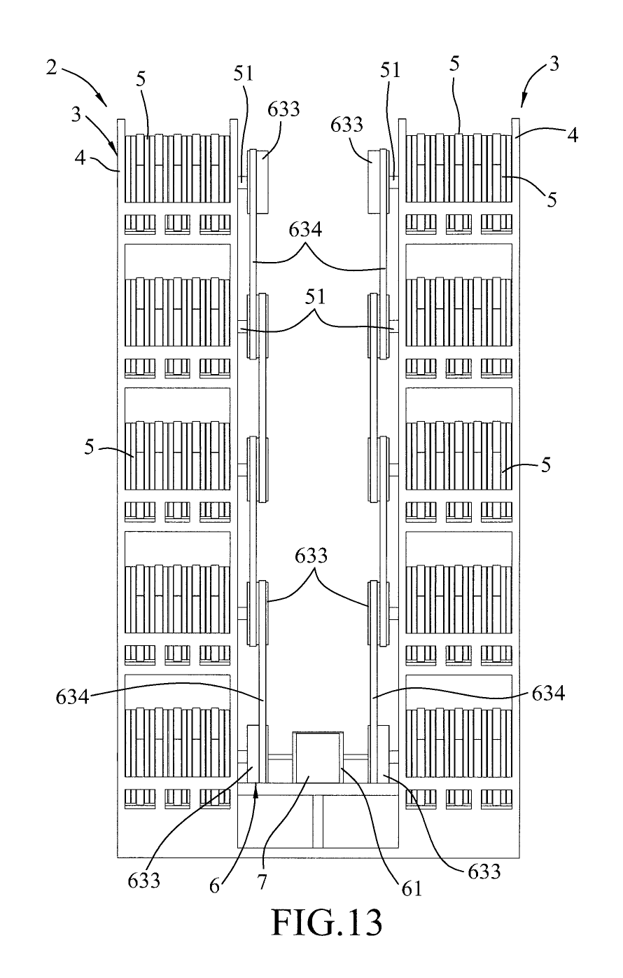

Referring to FIG. 13, a fifth embodiment of the electric generator 2 according to the present disclosure has a structure modified from that of the fourth embodiment.

In the fifth embodiment, the synchronizing mechanism 63 includes a plurality of bridging members 633 and a plurality of transmission members 634, and the transmission gears 631 and the synchronizing shafts 632 are omitted. The bridging members 633 are co-rotatably and respectively sleeved on the transmission shafts 51 of the electric generating mechanisms 5 of the electric generating devices 3. Each of the transmission members 634 co-rotatably interconnects two adjacent ones of the bridging members 633.

In certain embodiments, each of the bridging members 633 is a belt pulley, and each of the transmission members 634 is a transmission belt.

In certain embodiments, each of the bridging members 633 is a gear, and each of the transmission members 634 is a chain.

To sum up, the first mounting holes 534 of the magnetic plate body 532 of each of the magnetic plate modules 531 allow each of the magnets 537 of the corresponding magnetic plate module 531 to be exposed from the side plates 535 of the corresponding magnetic plate module 531, thereby reducing the number of the magnets 537 to half. The overall weight of the electric generator 2 is thus reduced, leading to better power generation efficiency.

The protrusions 524 of each of the wire tray modules 521 can be used for fixing the corresponding wire tray module 521 to the supporting frame 4 without the use of extra fixing mechanism, thereby reducing the overall elements necessary for assembling the electric generator 2.

The synchronizing mechanism 63 of the driving device 6 allows multiple electric generating mechanisms 5 to function together, thereby increasing the power generation capacity of the electric generator 2.

In the description above, for the purposes of explanation, numerous specific details have been set forth in order to provide a thorough understanding of the embodiments and variation. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments and variation, it is understood that this disclosure is not limited to the disclosed embodiments and variation but is intended to cover various arrangements included within the spirit and scope of the broadest interpretation so as to encompass all such modifications and equivalent arrangements.

What is claimed is:

1. An electric generator comprising:
at least one electric generating device including a supporting frame, and at least one electric generating mechanism that is mounted to said supporting frame, and that includes a transmission shaft rotatably mounted to said supporting frame, a wire tray unit disposed around said transmission shaft and fixedly mounted to said supporting frame, and a magnetic plate unit sleeved on said transmission shaft and including at least one magnetic plate module that includes a magnetic plate body co-rotatably sleeved on said transmission shaft, and a plurality of angularly spaced-apart magnets mounted to said magnetic plate body, said wire tray unit generating an electric power induced by relative rotation of said wire tray unit and said magnets of said magnetic plate unit; and
a driving device being connected to said transmission shaft and being driven by a part of the electric power to drive rotation of said transmission shaft.

2. The electric generator as claimed in claim 1, wherein said wire tray unit includes two wire tray modules that are disposed around said transmission shaft and that are respectively located at opposite sides of said at least one magnetic plate module, each of said wire tray modules generating an electric power induced by relative rotation of said wire tray module of a corresponding one of said wire tray modules and said magnets of said at least one magnetic plate module of said magnetic plate unit.

3. The electric generator as claimed in claim 1, wherein said wire tray unit includes a plurality of wire tray modules that are disposed around said transmission shaft, said magnetic plate unit including a plurality of said magnetic plate modules that are co-rotatably sleeved on said transmission shaft, said wire tray modules and said magnetic plate modules being alternatively arranged along said transmission shaft, each of said wire tray modules generating an electric power induced by relative rotation of a corresponding one of said wire tray modules and said magnets of two adjacent ones of said magnetic plate modules of said magnetic plate unit.

4. The electric generator as claimed in claim 3, wherein said supporting frame includes two parallel and spaced-apart supporting rods, each of said wire tray modules including at least one coil member, and a covering member having an annular cover body enclosing said at least one coil member and being disposed around said transmission shaft, and two protrusions that extend from said cover body and away from each other and that are respectively supported on said supporting rods.

5. The electric generator as claimed in claim 4, wherein said at least one electric generating device further includes a case that is mounted to said supporting frame, that covers said electric generating mechanism, and that is formed with a plurality of positioning holes, each of which is for engagement of a respective one of said protrusions of said cover bodies of said wire tray modules.

6. The electric generator as claimed in claim 3, wherein each of said magnetic plate modules further includes at least one side plate that is connected to a side of said magnetic plate body, said magnetic plate body of each of said magnetic plate modules having a plurality of first mounting holes that are arranged around said transmission shaft and spaced apart from each other, said at least one side plate of each of said magnetic plate modules having a plurality of second mounting holes that are respectively registered with said first mounting holes of said magnetic plate body of said magnetic plate module, each of said magnets of each of said magnetic plate modules extending through a corresponding registered pair of said first and second mounting holes.

7. The electric generator as claimed in claim 6, wherein each of said magnetic plate modules includes two of said side plates that are respectively connected to opposite sides of said magnetic plate body, each of said magnets of each of said magnetic plate modules extending through corresponding ones of said first and second mounting holes.

8. The electric generator as claimed in claim 1, wherein said at least one electric generating device includes a plurality of said electric generating mechanisms that are mounted to said supporting frame and that are spaced apart from each other, said driving device including a driving unit that is connected to one of said transmission shafts of said electric generating mechanisms, and a synchronizing mechanism that is connected to said transmission shafts of said electric generating mechanisms, said driving unit being operable to drive rotation of said one of said transmission shafts and to drive operation of said synchronizing mechanism such that said synchronizing mechanism drives synchronous rotation of said transmission shafts.

9. The electric generator as claimed in claim 8, wherein said synchronizing mechanism includes a plurality of transmission gears that mesh with each other, and that are co-rotatably and respectively sleeved on said transmission shafts of said electric generating mechanisms.

10. The electric generator as claimed in claim 8, wherein said synchronizing mechanism includes a plurality of bridging members that are co-rotatably and respectively sleeved on said transmission shafts of said electric generating mechanisms, and a plurality of transmission members, each of which co-rotatably interconnects two adjacent ones of said bridging members.

11. The electric generator as claimed in claim 10, wherein each of said bridging members is a belt pulley, each of said transmission members being a transmission belt.

12. The electric generator as claimed in claim 10, wherein each of said bridging members is a gear, each of said transmission members being a chain.

13. The electric generator as claimed in claim 1, comprising two of said electric generating devices, said driving device being operable to drive rotation of said transmission shafts of said electric generating mechanisms of said electric generating devices.

14. The electric generator as claimed in claim 13, wherein each of said electric generating devices includes a plurality of said electric generating mechanisms that are mounted to said supporting frame and that are spaced apart from each other, said driving device including a driving unit that is connected to one of said transmission shafts of said electric generating mechanisms of each of said electric generating devices, and a synchronizing mechanism that is connected to said transmission shafts of said electric generating mechanisms of said electric generating devices, said driving unit being operable to drive rotation of said one of said transmission shafts of said electric generating mechanisms of each of said electric generating devices and to drive operation of said synchronizing mechanism such that said synchronizing mechanism drives synchronous rotation of said transmission shafts of said electric generating mechanisms of said electric generating devices.

15. The electric generator as claimed in claim 14, wherein said synchronizing mechanism includes a plurality of transmission gears that are co-rotatably and respectively sleeved on said transmission shafts of said electric generating mechanisms of said electric generating devices, ones of said transmission gears connected to said transmission shafts of said electric generating mechanisms of each of said electric generating devices co-rotatably mesh with each other.

16. The electric generator as claimed in claim 15, wherein said synchronizing mechanism further includes a plurality of synchronizing shafts, each of which co-rotatably interconnects one of said transmission gears connected to one of said transmission shafts of said electric generating mechanisms of one of said electric generating devices and a corresponding one of said transmission gears connected to one of said transmission shafts of said electric generating mechanisms of the other one of said electric generating devices.

17. The electric generator as claimed in claim 14, wherein said synchronizing mechanism includes a plurality of bridging members that are co-rotatably and respectively sleeved on said transmission shafts of said electric generating mechanisms of said electric generating devices, and a plurality of transmission members, each of which co-rotatably interconnects two adjacent ones of said bridging members.

18. The electric generator as claimed in claim 17, wherein each of said bridging members is a belt pulley, each of said transmission members being a transmission belt.

19. The electric generator as claimed in claim 17, wherein each of said bridging members is a gear, each of said transmission members being a chain.

20. The electric generator as claimed in claim 1, further comprising a power controller that electrically interconnects said wire tray unit of said at least one electric generating mechanism of said at least one electric generating device and said driving device, said power controller including a charging controller that is electrically connected to said wire tray unit and that receives the electric power generated by said wire tray unit, an electric power storage device that is electrically connected to said charging controller and that stores the electric power delivered from said charging controller, and a discharging controller that is electrically connected to said electric power storage device and that receives the electric power delivered from said electric power storage device and that delivers the part of the electric power to said driving device to drive operation of said driving device.

21. A wire tray module adapted to be mounted to two supporting rods of a supporting frame of an electric generator, said wire tray module comprising:
at least one coil member; and
a covering member having an annular cover body that encloses said at least one coil member, and two protrusions that extend from said cover body and away from each other and that are adapted to be respectively supported on the supporting rods.

22. The wire tray module as claimed in claim 21, wherein said cover body further has an output end piece that is disposed on one of said protrusions and that is electrically connected to said at least one coil member.

23. The wire tray module as claimed in claim 21, comprising a plurality of said coil members that are enclosed by said cover body.

24. A magnetic plate module adapted to be used by an electric generator, said magnetic plate module comprising:
a magnetic plate body that has a plurality of first mounting holes spaced apart from each other and arranged around a center axis of said magnetic plate body; and
a plurality of magnets that respectively extend through said first mounting holes and that are exposed from opposite sides of said magnetic plate body.

25. The magnetic plate module as claimed in claim 24, further comprising at least one side plate that is connected a side of said magnetic plate body, said at least one side plate having a plurality of second mounting holes that are respectively registered with said first mounting holes of said magnetic plate body, each of said magnets extending through a corresponding registered pair of said first and second mounting holes.

26. The magnetic plate module as claimed in claim 25, wherein said magnetic plate module comprises two of said side plates that are respectively connected to opposite sides of said magnetic plate body, each of said magnets extending through corresponding ones of said first and second mounting holes.
